(19) United States
(12) Patent Application Publication
(10) Pub. No.: US 2012/0185881 A1
(43) Pub. Date: Jul. 19, 2012

(54) Debugging Support For Core Virtual Machine Server

(76) Inventor: Nathaniel C. Begeman, San Jose, CA (US)

(21) Appl. No.: 13/006,386

(22) Filed: Jan. 13, 2011

(51) Int. Cl. G06F 9/44

(52) U.S. Cl. 719/332

(57) ABSTRACT

A method and apparatus of a device that adds debugging support for compiling applications in memory using a core virtual machine server is described. In an exemplary method, the device receives source code for an executable. The device generates an internal representation of the source code and generates an object file in the memory of the device from the internal representation. The device links the object file to resolve one or more external symbols in the object file without storing the executable in a filesystem of the device.

### FIELD OF INVENTION

This invention relates generally to application compilation and more particularly to adding debugging support for application in memory compilation using the core virtual machine server.

### BACKGROUND OF THE INVENTION

Compilation is the act of converting source code that is written in a programming language (C, C++, Objective-C, Java, Pascal, FORTRAN, etc.) into an executable that can be executed by the operating system of a particular device. Compilation can be compiling the source code into an intermediate code that can be later assembled into object code. The object code is linked with external libraries to product the executable. The executable can be a stand-alone executable or a type of library (static library, dynamically linked library, etc.). During the compilation, the intermediate code, object code and resulting executable are stored as separate files on a file system of the device doing the compilation. The client making the compilation request will then read the stored executable and execute it.

In addition, compilation tools have the option of including debugging information in the resulting executable. A debugger, crash analyzer, and/or profiling tool uses this information to analyze the executable as or after the executable has been running.

For security and performance reasons, the compilations may not have access to a file system to store the object code and/or the resulting executable with or without debugging information. For example, a portable device (e.g., smartphone, etc.) may not allow a client application access to the file system. In addition, a client may not be able to compile and store an external library. Thus, it would be useful to compile and link an executable in memory with debugging information embedded in the resulting executable.

### SUMMARY OF THE DESCRIPTION

A method and apparatus of a device that adds debugging support for compiling applications in memory using a core virtual machine server is described. In an exemplary method, the device receives source code for an executable. The device generates an internal representation of the source code and generates an object file in the memory of the device from the internal representation. The device links the object file to resolve one or more external symbols in the object file without requiring storage of the executable in a filesystem of the device.

In a further embodiment, the device receives source code for an executable. The device generates an internal representation of the source code and generates an object file in the memory of the device from the internal representation. The device links the object file to resolve one or more external symbols in the object file to create an in-memory executable without storing the in-memory executable in a filesystem of the device. Furthermore, the in-memory executable is debuggable and includes loader instructions embedded in the in-memory executable.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 is a block diagram of one embodiment of system that is used to compile multiple applications.

FIG. 2 is a block diagram of one embodiment of a system that compiles an application in memory without storing the executable in a filesystem of a device.

FIGS. 3A and 3B are flow diagrams of embodiments of a process to perform in-memory compilation of source code and further execute the resulting executable in memory.

FIG. 4 is a flow diagram of one embodiment of a process to generate an object file in memory.

FIG. 5 is a flow diagram of one embodiment of a process to generate an executable in memory by dynamically linking the object file.

FIGS. 6A and 6B are block diagrams of an in-memory compiler module that performs in-memory compilation.

FIG. 7 is a block diagram of one embodiment of an object generation module to generate an object file in memory.

FIG. 8 is a block diagram of one embodiment of a dynamic link module to generate an executable in memory by dynamically linking the object file.

FIG. 9 illustrates one example of a typical computer system, which may be used in conjunction with the embodiments described herein.

FIG. 10 shows an example of a data processing system, which may be used with one embodiment of the present invention.

### DETAILED DESCRIPTION

A method and apparatus of a device that adds debugging support compiling applications using a core virtual machine server is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that adds debugging support for compiling applications in memory using, for example, a core virtual machine server is described. In one embodiment, a core virtual machine server can be a compiler or compiler server that performs just in time compilations for client software modules that, at run time of those modules, request that source code be compiled when is needed (rather than when the client software is initially launched and executed). In an exemplary method, the device receives source code for an executable. The device generates an internal representation of the source code and generates an object file in the memory of the device from the internal representation. The device links the object file to resolve one or more external symbols in the object file without retrieving the executable from a file stored in a filesystem of the device.

In one embodiment, a compiler receives source code from a client. The compiler compiles this source into object code that is stored in memory without the compiler storing the object code on the file system of the device running the compiler. The compiler further dynamically links the object code with external libraries and/or other symbols by inserting loader commands into the object code. The compiler provides the executable to the client as executable memory. The client can access this memory and execute the executable stored in this memory without storing the executable in a file system. Further, the executable can be debugged by a debugger that is designed to be used with an executable stored in a file in a filesystem.

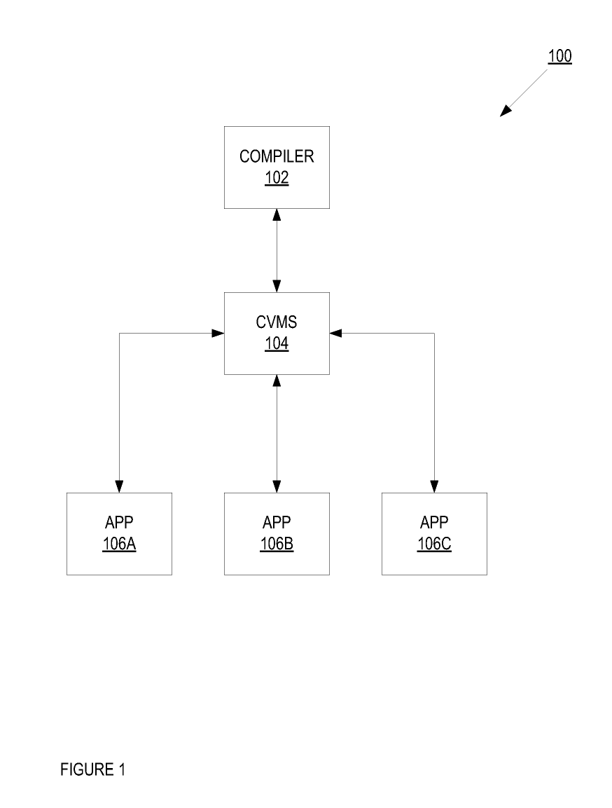

FIG. 1 is a block diagram of one embodiment of system 100 that is used to compile multiple applications 106A-C. In FIG. 1, system 100 includes a compiler 102 and a core virtual machine server 104 to compile applications 106A-C. In one embodiment, the compiler 102 is a program that decodes source code and produces an object file. In one embodiment, multiple different and/or the same compilers can be substituted for a single compiler 102. As known in the art, an object file is an organized collection of separate, named sequences of machine code. Each sequence, or object, can contain instructions for a device to accomplish some task, possibly accompanied by related data and metadata (e.g. relocation information, stack unwinding information, comments, program symbols, dynamic loader instructions, debugging or profiling information, etc.). Furthermore, the compiler 102 can link the object file with external libraries to produce an executable. In one embodiment, an executable is a file that causes a device to perform an indicated task according to encoded instructions, as opposed to a data file that must be parsed by a program to be meaningful. These instructions are traditionally machine code instructions for a physical central processing unit (CPU). In one embodiment, the source code can be a set of instructions written in a higher order language as known in the art (C, C++, Objective-C, Java, Pascal, FORTRAN, etc.). For example and in one embodiment, an executable may be a stand alone executable, library of functions, shared library, dynamic link library, archive of object files, dynamic library, static library, etc., and/or any other known executable in the art.

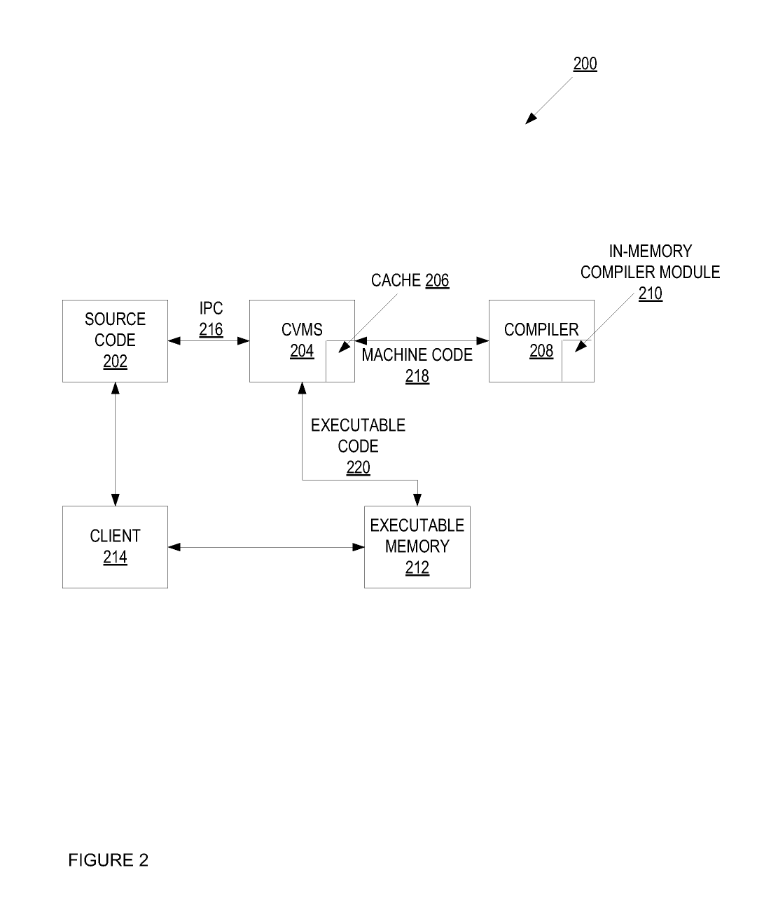

In one embodiment, the Core Virtual Machine Server (CVMS) 104 is a service that allows the multiple applications 106A-C to take advantage of the compiler 102 or a plurality of compilers. In one embodiment, the CVMS 104 receives compilation requests from applications 106A-C. These requests can be “just in time” (JIT) compilation requests made while the applications 106A-C are running and occur when these applications 106A-C need the services provided by the source code. JIT compilation processes are described in U.S. patent application Ser. No. 12/477,859, entitled “METHODS AND APPARATUSES FOR A COMPILER SERVER,” filed on Jun. 3, 2009 and U.S. patent application Ser. No. 12/477,866, entitled “METHODS AND APPARATUSES FOR SECURE COMPILATION,” filed on Jun. 3, 2009, which are incorporated herein by reference. In this embodiment, the CVMS 104 checks to see if the CVMS 104 can fulfill the compilation request from the cache maintained by the CVMS 104. If the compilation request can be fulfilled, the CVMS 104 sends the requesting application the compiled executable. If CVMS 104 cannot fulfill the compilation request, the CVMS 104 performs a security check on the compilation request and passes the compilation request to the compiler 102. In one embodiment, the compiler 102 returns the compiled executable to the CVMS 104, which can store the compiled executable in the cache of the CVMS 104. The CVMS 104 sends the compiled executable to the requesting application 106A-C. In one embodiment, the compiler 102 and CVMS 104 fulfill the compilation request without storing the executable in a file system of the device that is hosting the CVMS 104 and compiler 102. Fulfilling the compilation request is further described in FIG. 2 below.

In one embodiment, applications 106A-C are programs that make use of the compilation process. While in one embodiment, the applications 106A-C can be a software development environment, in alternate embodiments, the applications 106A-C can be an application that can take advantage of compilation services (e.g., an application that can compile a plug-in (photo editor, security software, etc.), just-in-time compilation, etc.). For example and in one embodiment, a digital video disc (DVD) application may compile a security code on the fly into an executable where this compiled security code is used to control the playback of a DVD.

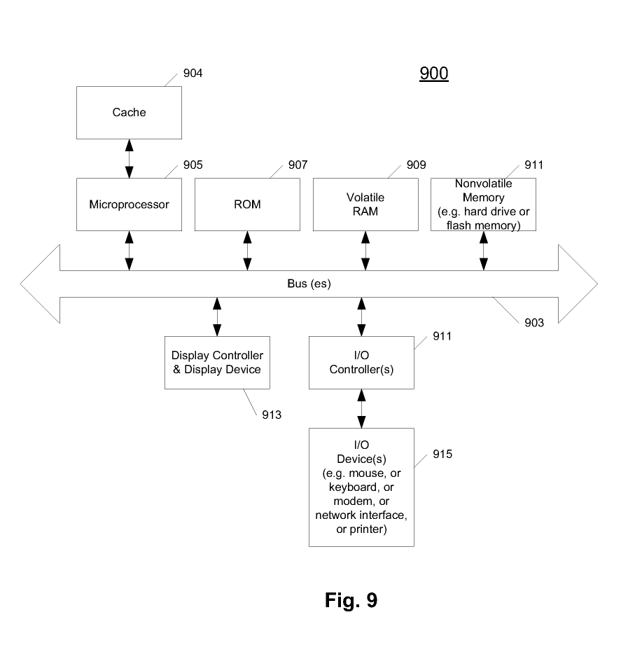

FIG. 2 is a block diagram of one embodiment of a system 200 that compiles an application in memory without storing the executable in a filesystem of a device. While in one embodiment, system 200 is performed by a single device (e.g., the computer system 900 as illustrated in FIG. 9), in alternate embodiments, system 200 is performed by multiple devices (e.g., one computer system hosting the CVMS 204 and compiler 208 and another computer system providing the source code 202 and hosting the client 214 that is using the compilation services provided by the CVMS 204 and compiler 208).

In FIG. 2, client 214 provides the source code 202 to CVMS 204. In one embodiment, CVMS 204 is the CVMS 104 that fulfills compilation requests as described in FIG. 1 above. In one embodiment, client 214 provides the source code 202 via an inter-process communication 216 as known in the art. In one embodiment, source code 202 is the source code as described above in FIG. 1. In one embodiment, CVMS 204 performs a security check on the source code. For example and in one embodiment, the CVMS 204 can perform a security check that is a cryptographic hash of the source code matches a pre-computed hash stored alongside the source code.

In one embodiment, the CVMS 204 includes a cache 206 that stores compiled executables (e.g., executables that were compiled in a JIT compilation process) for later retrieval by client 214. For example and in one embodiment, the CVMS 204 stores the executable memory 212 that was compiled by the compiler 208 for later retrieval by the client 214 in the cache 206. In this example, when the client 214 makes a compilation request (which can be a JIT compilation request) to the CVMS 204, the CVMS 204 checks the cache 206 to determine if the compiled executable is present in the cache 206. If the compiled executable matching the requested compilation is present, the CVMS 204 transmits the compiled executable as an executable memory 212 to the requesting client 214. If the compiled executable is not in the cache 206, the CVMS 204 relays the compilation request to the compiler 208, which can then compile the source code.

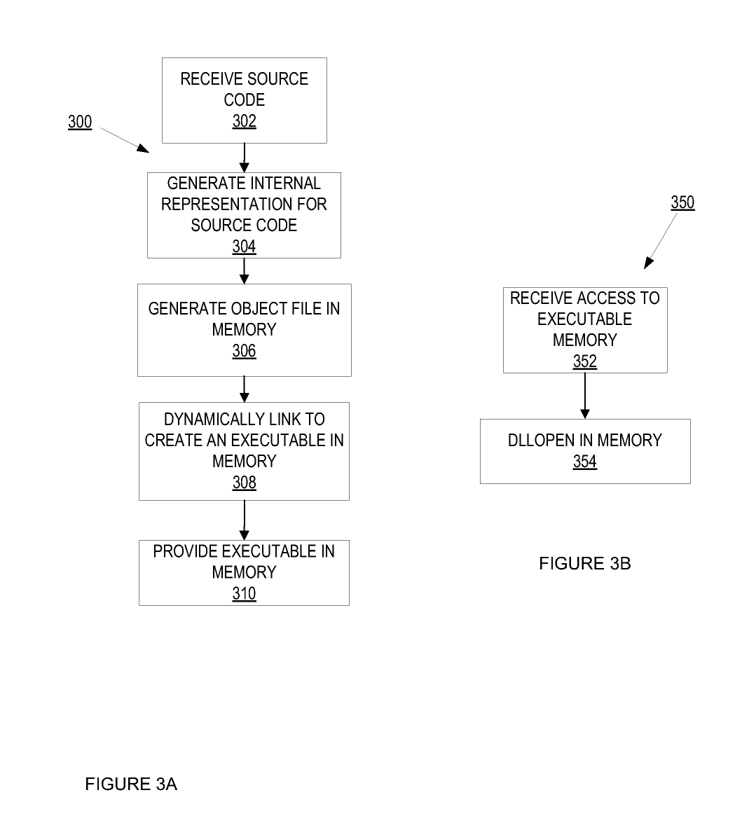

In one embodiment, compiler 208 receives the compilation request from the CVMS 204 and compiles the source code 202 using an in-memory compiler module 210. In one embodiment, the in-memory compiler module 210 compiles the source code without storing the resulting executable in a file system of the device that is performing the compilation. A resulting executable is an executable that results from the compilation request. In this embodiment, the in-memory compiler module 210 compiles the source code into an object file and links this object file into an executable code 220 that is stored in the executable memory 212. In one embodiment, the executable memory 212 is physical memory or virtual memory whose page table entry has the executable privilege bit set. In this embodiment, a processor may fetch instructions to be executed from executable memory. In one embodiment, client 214 can execute the executable memory 212 by performing a dlopen call on the executable memory 212. For example and in one embodiment, a call to dlopen(“/path/to/my/library.dylib”, RTLD_LOCAL) opens a dynamic library named “library.dylib” at the path “/path/to/my/library.dylib” and marks its symbols as being able to be resolved by the handle returned by dlopen. Operation of the in-memory compiler module 210 to compile the executable code 220 into the executable memory 212 and executing the executable memory 212 is further described in FIG. 3AB below.

As described above, the in-memory compiler module 210 can compile the source code into executable memory 212 that is executed by the requesting client 214. FIG. 3A is a flow diagram of one embodiment of a process 300 to perform in-memory compilation of source code. In one embodiment, FIG. 3A can be performed by in-memory compiler module 210 as described in FIG. 2 above. In FIG. 3A, process 300 receives the source code to be compiled at block 302. While in one embodiment, process 300 receives the source code from the CVMS 204 as described in FIG. 2 above, in alternate embodiments, process 300 receives the source code from alternate sources (e.g., from the client 214, etc.). In one embodiment, the received source code may be the result of JIT compilation request.

At block 304, process 300 generates the internal representation for the source code. In one embodiment, the internal representation is a set of data that includes instructions and metadata. In this embodiment, the instructions are bit codes. Furthermore, the metadata is data that gives other applications a way to analyze the executable that is to be stored in memory. For example and in one embodiment, the metadata can include symbols, line numbers, location information, type names, memory access volatility and alignment, etc. In one embodiment, the types of applications that can be used to analyze the executable are a debugger, crash analyzer, backtrace, profiler, etc.

For example and in one embodiment, process 300 can convert an instruction such as “foo(arg1, arg2, . . . , argN)” into the following internal representation instructions:

mv arg1 into storage
...
mv argN into storage
jump to foo

in which these arguments first store arg1, arg2, argN into storage and then jumps to the initial point to where the function “foo” is stored so as to execute “foo.” Furthermore, in this embodiment, the instructions that are “my argI into storage” are storage instructions and the “jump” instruction is a relocation instruction.

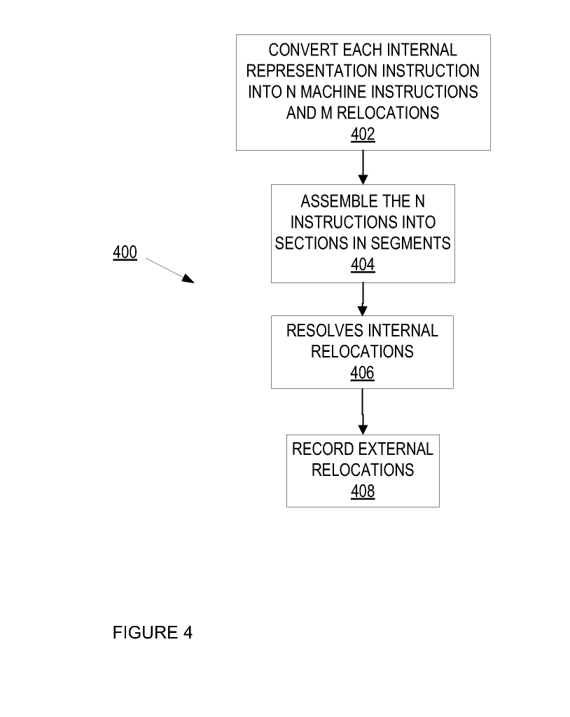

Process 300 generates an object file in memory at block 306. In one embodiment, process 300 generates the object file by turning the internal representation instructions into machine instructions and locations and resolving/recording those instructions. Generating the object file is further described in FIG. 4 below.

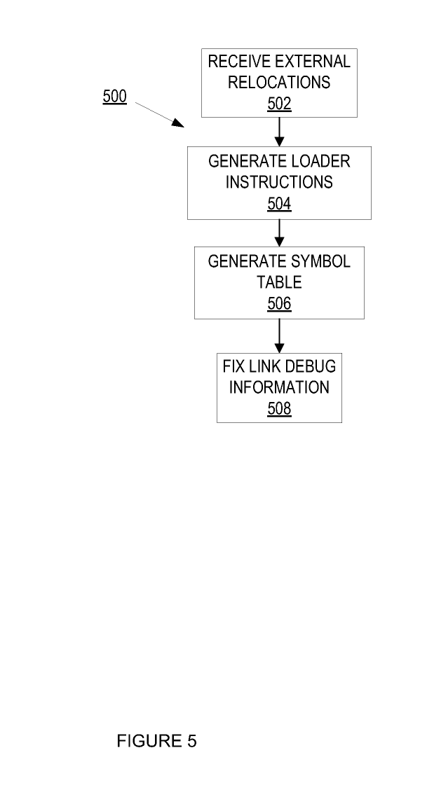

At block 308, process 300 dynamically links the object file to create the executable in memory. In one embodiment, process 300 dynamically links the object file by resolving external locations, generating loader instructions and a symbol table, and establishing the link debug information. Dynamically linking the object file is further described in FIG. 5 below. Process 300 provides the executable in memory at block 310. In one embodiment, process 300 provides a memory range of where the executable is stored so that the requesting client can execute this executable. Executing the executable in memory is further described in FIG. 3B below.

FIG. 3B is a flow diagram of one embodiment of a process 350 to execute the resulting executable in memory. In one embodiment, FIG. 3A can be performed by the client 214 as described in FIG. 2 above. Process 350 begins by receiving access to the executable memory at block 352. In one embodiment, process receives the access parameters as provided by process 300 at block 310 above. For example and in one embodiment, process 350 receives a range in memory of where the executable is stored so that process 350 can execute this executable. Process 350 executes this executable by performing a dlopen on the memory range at block 354. For example and in one embodiment, process 350 receives a handle to the library of executable code. In this embodiment, process 350 can inquire using the dynamic loader via dlsym( ) for the address of each symbol (function) it wishes to call, and transfers program control to those addresses. Alternatively, process 350 directly inspects the library for the addresses of the functions process 350 cares about.

FIG. 4 is a flow diagram of one embodiment of a process 400 to generate an object file in memory. In one embodiment, process 400 is performed by process 300 in FIG. 3 at block 304 above. Process 400 begins by converting each internal representation instructions into N machine instructions and M relocations at block 402. In one embodiment, a machine instruction can be a set of instructions represented in the instruction set that is specific to the device's central processing unit (CPU). As in known in the art, machine instructions are patterns of bits that by physical design correspond to different commands to the machine. In one embodiment, a relocation is the act of replacing symbolic references or names of libraries with useable addresses in memory. Relocations can either be internal or external relocations. An internal relocation is a relocation that is replacing a symbolic name or name of library that is defined in the source code that is being compiled by process 400. For example and in one embodiment, an internal relocation can be a replacement of a constant, variable and/or function that is defined in that source code. An external relocation is a relocation that is replacing a symbolic name or name of library that is defined outside the source code that is being compiled by process 400. For example and in one embodiment, an external relocation can be a replacement of a constant, variable, and/or function that is defined in an externally defined library.

For example and in one embodiment, with reference to the internal representation instructions illustrated in FIG. 3A, block 304 above, the following instructions,

mv arg1 into storage
...
mv argN into storage
jump to foo

are converted into the machine instructions and relocations as follows:

mv memAddr1A into memAddr1B
...
mv memAddrNA into memAddrNB
jump to memAddrFoo

in which the first set of arguments are storage instructions and the last instruction is a relocation. As described above, at relocation can be either internal or external.

Process 400 assembles the instructions into sections in segments. In one embodiment, each section contains a particular kind of data (instructions, constant values, writable data, relocations, etc.). In one embodiment, these sections are processed by the loader at dlopen( ) time to set permissions and fixup external relocations as appropriate.

At block 406, process 400 relocates the internal representations. As described above, an internal relocation is a relocation that is replacing a symbolic name or name of library that is defined in the source code that is being compiled by process 400. For example and in one embodiment, an internal relocation can be a replacement of a constant, variable and/or function that is defined in that source code. For example and in one embodiment, and with reference to the jump described above, assumes for this embodiment that “foo” is a function that is defined in the source code being compiled by process 300. In one embodiment, process 400 would relocate the jump to memAddrFoo to a jump forward/backwards a distance from the current place in memory. For example and in one embodiment, process 400 resolves the instruction “jump to memAddrFoo” to “jump Atom 8” or jump forward 4 bytes.” In these examples, process 400 has resolved the jump instruction from a jump to a symbolic memory address (“memAddrFoo”) to a jump to a specific memory address (e.g., “jump forward 4 bytes”).

Process 400 records the external relocations at block 408. As described above, an external relocation is a relocation that is replacing a symbolic name or name of library that is defined outside the source code that is being compiled by process 400. For example and in one embodiment, an external relocation can be a replacement of a constant, variable, and/or function that is defined in an externally defined library. Because the relocation is to an external symbol, process 400 records this relocation that will be later resolved with the linker process as described in FIG. 5 below.

For example and in one embodiment, and with reference to the jump described above, assumes for this embodiment that “foo” is a function that is defined outside of the source code being compiled by process 300. In one embodiment, process 400 records that this symbol is to be resolved during the linking process. In one embodiment, process 400 records “jump to memAddrFoo” as a name of the function to be resolved, and a field indicating that this function name is undefined (e.g., no implementation in this object). By marking the function as undefined, this function is to be resolved during linking.

As described above, for the object code to be executable, a dynamic linking process is used to resolve the external symbols that were recorded in FIG. 4, block 408 described above. FIG. 5 is a flow diagram of one embodiment of a process 500 to generate an executable in memory by dynamically linking the object file. In FIG. 5, process 500 begins by receiving the external locations at block 502. In one embodiment, process 500 receives the list of external relocations that was recorded by process 400 in FIG. 4 at block 408 above. In one embodiment, a recorded external relocation is a function name to be resolved and marked as undefined.

At block 504, process 500 generates loader instructions. In one embodiment, process 500 generates loader instructions by inserting code that is used by a loader for resolving the external relocations. These instructions are used by the loader that executes the resulting executable so that the external symbols can be resolved. For example and in one embodiment, process 500 can generate the loader instruction as “write address of symbol sin( ) at offset +500 bytes from start of section 2” to resolve the symbol “sin( )”. In one embodiment, these loader instructions are not saved to disk but are instead inserted into a memory location that is accessible for the process that executes the resulting executable. In one embodiment, process 500 may match each external relocation to the external library containing the target symbol of the relocation, so that in block 504, process 500 has the information it needs (final address and type of relocation, target symbol, target library) to instruct the dynamic loader on how to rewrite the program at load time such that all external references are correctly resolved.

Process 500 generates the symbol table at block 506. In one embodiment, the symbol table is a data structure used by a language translator such as a compiler or interpreter, where each identifier in a program's source code is associated with information relating to its declaration or appearance in the source, such as its type, scope level and sometimes its location. In one embodiment, the symbol table is embedded in the resulting executable so that the data in the symbol table can be used later. For example and in one embodiment, the symbol table can be used by a debugger for debugging the executable, to give a backtrace if the executable crashes, by a profiler to profile the resources used by the executable, etc., and/or combination therein. In one embodiment, the symbol table can contain names of the variables, functions, constants, relocation information, stack unwinding information, comments, program symbols, debugging or profiling information, memory locations, etc., and/or combinations therein.

For example and in one embodiment, a debugger uses the symbol table of the executable to present debug information as the debugger executes that executable. For example and in one embodiment, a debugger will request that source code is compiled with the debugging information included in the resulting executable. In this example, the debugger receives the executable and allows a user to step through the executable to examine how the executable is run. In one embodiment, the source code is compiled in a JIT compilation process can be debugged with a debugger that is designed to operate on an object code file stored in a file in a filesystem.

As another example, a profiler is a program that can track the performance of the executable. For example and in one embodiment, the profiler uses the symbol table and the other metadata to determine which sections of a program to optimize, for example, to increase its overall speed, decrease its memory requirement or both.

As a further example, a crash analyzer can use the symbol table to determine where the executable crashed using the backtrace information. Furthermore, the crash analyzer may give memory locations of the variables and function calls in the backtrace information and may also provide the values of the variables in the function calls.

In one embodiment, process 500 maps the symbols between sections and offset of the sections to the resulting executable. For example and in one embodiment, process 500 maps symbols such as “symbol A is in section 2, offset 0 bytes”, “symbol B is in section 2, offset 20 bytes”, “symbol C is in section 6 offset 0 bytes”, etc.

At block 508, process 500 optionally fixes the link debug information in the resulting executable. In one embodiment, process 500 resolves debug information using the internal relocation methods as described in FIG. 4, block 406. At the end of process 500, the object file has been transformed into an executable that can be executed by the client that requested the compilation.

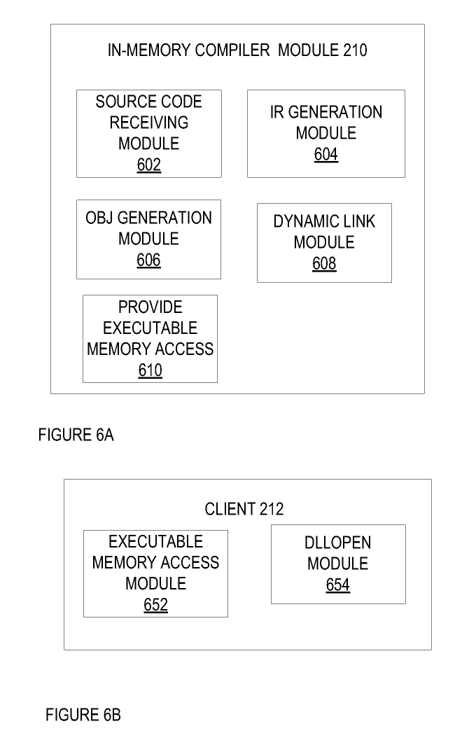

As described in FIGS. 3-5, source code is compiled and linked in memory to produce an executable that can be directly executed from memory with the metadata that can be used by a client. FIG. 6A is a block diagram of an in-memory compiler module 210 that performs in-memory compilation. In one embodiment, in-memory compiler module 210 is used by compiler 208 as described above in FIG. 2. In FIG. 6A, in-memory compiler module 210 includes source code receiving module 602, IR generation module 604, object generation module 606, dynamic link module 608, and provide executable memory access module 610. In one embodiment, the source code receiving module 602 receives the source code as described in FIG. 3A, block 302 above. The IR generation module 604 generates the internal representation code for the received source code as described in FIG. 3A, block 304 above. The object generation module 606 generates the object code as described in FIG. 3A, block 306 above. The dynamic link module 608 dynamically links the object code into an executable as described in FIG. 3A, block 308 above. The provide executable memory access module 610 provides access to the executable memory as described in FIG. 3A, block 310 above.

FIG. 6B is a block diagram of one embodiment of a client 212 to execute an executable in memory. In one embodiment, client 212 includes executable memory access module 652 and Dlopen module 654. The executable memory access module 652 receives access to the executable memory as described in FIG. 3B, block 352 above. The Dlopen module 654 opens and executes the executable as described in FIG. 3B, block 354 above.

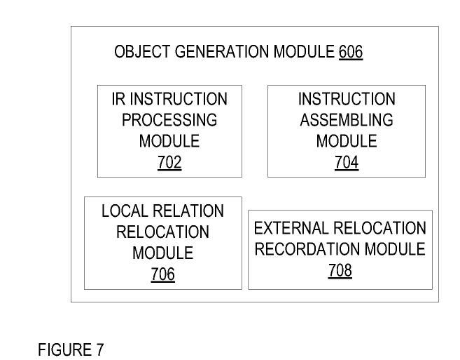

FIG. 7 is a block diagram of one embodiment of an object generation module 606 to generate an object file in memory. In one embodiment, object generation module 606 incudes IR instructions processing module 702, instruction assembling module 704, local relocation restoration module 706, and external relocation recordation module 708. The IR instructions processing module 702 converts each internal representation instruction as described in FIG. 4, block 402 above. The instruction assembling module 704 assembles instructions as described in FIG. 4, block 404 above. The local relocation restoration module 706 resolves internal relocations as described in FIG. 4, block 406 above. The external relocation recordation module 708 records external relocations as described in FIG. 4, block 408 above.

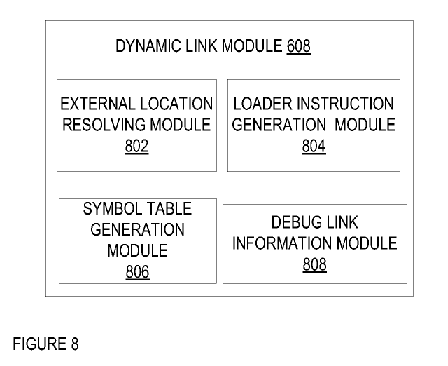

FIG. 8 is a block diagram of one embodiment of a dynamic link module 608 to generate an executable in memory by dynamically linking the object file. In one embodiment, the dynamic link module 608 includes external location resolving module 802, loader instruction generation module 804, symbol table generation module 806, and debug link information module 808. The external location resolving module 802 resolving the external relocations as described in FIG. 5, block 502 above. The loader instruction generation module 804 generates the loader instructions as described in FIG. 5, block 504 above. The symbol table generation module 806 generates the symbol table as described in FIG. 5, block 506 above. The debug link information module 808 fixes the link debug information as described in FIG. 5, block 508 above.

FIG. 9 shows one example of a data processing system 900, which may be used with one embodiment of the present invention. For example, the system 900 may be implemented including a host as shown in FIG. 1. Note that while FIG. 9 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 9, the computer system 900, which is a form of a data processing system, includes a bus 903 which is coupled to a microprocessor(s) 905 and a ROM (Read Only Memory) 907 and volatile RAM 909 and a non-volatile memory 911. The microprocessor 905 may retrieve the instructions from the memories 907, 909, 911 and execute the instructions to perform operations described above. The bus 903 interconnects these various components together and also interconnects these components 905, 907, 909, and 911 to a display controller and display device 913 and to peripheral devices such as input/output (I/O) devices which may be mice, keyboards, modems, network interfaces, printers and other devices which are well known in the art. Typically, the input/output devices 915 are coupled to the system through input/output controllers 917. The volatile RAM (Random Access Memory) 909 is typically implemented as dynamic RAM (DRAM), which requires power continually in order to refresh or maintain the data in the memory.

The mass storage 911 is typically a magnetic hard drive or a magnetic optical drive or an optical drive or a DVD RAM or a flash memory or other types of memory systems, which maintain data (e.g. large amounts of data) even after power is removed from the system. Typically, the mass storage 911 will also be a random access memory although this is not required. While FIG. 9 shows that the mass storage 911 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 903 may include one or more buses connected to each other through various bridges, controllers and/or adapters as is well known in the art.

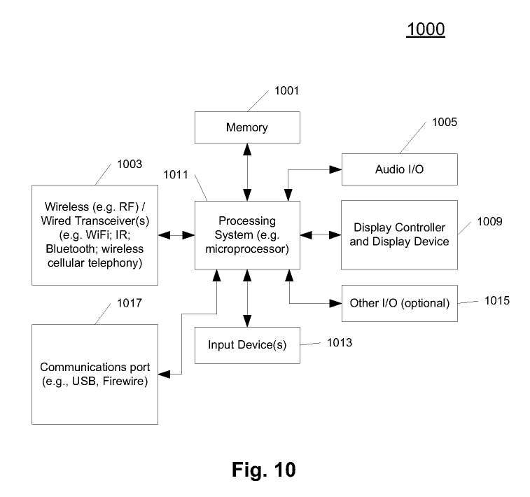

FIG. 10 shows an example of another data processing system 1000 which may be used with one embodiment of the present invention. For example, system 1000 may be implemented as a portable storage device as shown in FIG. 1. The data processing system 1000 shown in FIG. 10 includes a processing system 1011, which may be one or more microprocessors, or which may be a system on a chip integrated circuit, and the system also includes memory 1001 for storing data and programs for execution by the processing system. The system 1000 also includes an audio input/output subsystem 1005 which may include a microphone and a speaker for, for example, playing back music or providing telephone functionality through the speaker and microphone.

A display controller and display device 1009 provide a visual user interface for the user; this digital interface may include a graphical user interface which is similar to that shown on a Macintosh computer when running OS X operating system software, or Apple iPhone when running the iOS operating system, etc. The system 1000 also includes one or more wireless transceivers 1003 to communicate with another data processing system, such as the system 1000 of FIG. 10. A wireless transceiver may be a WLAN transceiver, an infrared transceiver, a Bluetooth transceiver, and/or a wireless cellular telephony transceiver. It will be appreciated that additional components, not shown, may also be part of the system 1000 in certain embodiments, and in certain embodiments fewer components than shown in FIG. 10 may also be used in a data processing system. The system 1000 further includes one or more communications ports 1017 to communicate with another data processing system, such as the system 1500 of FIG. 15. The communications port may be a USB port, Firewire port, Bluetooth interface, etc.

The data processing system 1000 also includes one or more input devices 1013, which are provided to allow a user to provide input to the system. These input devices may be a keypad or a keyboard or a touch panel or a multi touch panel. The data processing system 1000 also includes an optional input/output device 1015 which may be a connector for a dock. It will be appreciated that one or more buses, not shown, may be used to interconnect the various components as is well known in the art. The data processing system shown in FIG. 10 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device or an embedded device or other consumer electronic devices. In other embodiments, the data processing system 1000 may be a network computer or an embedded processing device within another device, or other types of data processing systems, which have fewer components or perhaps more components than that shown in FIG. 10.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple, Inc. of Cupertino, Calif., a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. Pat. No. 7,345,671 and U.S. published patent number 2004/0224638, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “computing,” “receiving,” “generating,” “linking,” “executing,” “transmitting,” “storing,” “receiving,” “assembling,” “transferring”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method to dynamically generate an executable in memory of a device, the method comprising:
receiving source code for the executable;
generating an internal representation of the source code;
generating an object file in the memory of the device from the internal representation; and
dynamically linking the object file to resolve one or more external symbols in the object file to create the executable, wherein the executable is debuggable without requiring storage of the executable in a filesystem of the device.

2. The non-transitory machine-readable medium of claim 1, wherein the method further comprises:
executing the executable and wherein the source is compiled in a just in time compilation process.

3. The non-transitory machine-readable medium of claim 1, wherein the generation of the object file comprises:
converting each internal representation instruction in the internal representation of the source code into machine instructions and relocations, wherein the relocations include local and external relocations;
assembling each of the machine instructions into sections in segments;
resolving the local relocations; and
recording the external relocations.

4. The non-transitory machine-readable medium of claim 1, wherein the dynamic linking comprises:
receiving the object file, wherein the object file includes external relocations;
resolving the external relocations;
generating loader instructions;
generating a symbol table; and
loading debug information.

5. The non-transitory machine-readable medium of claim 1, wherein the filesystem is read-only.

6. The non-transitory machine-readable medium of claim 1, wherein the method further comprises:
caching the executable.

7. The non-transitory machine-readable medium of claim 1, wherein the symbol table include symbol names and backtrace information.

8. The non-transitory machine-readable medium of claim 1, wherein a local relocation is a transition from a location in the executable to another location in the executable.

9. The non-transitory machine-readable medium of claim 1, wherein an external relocation is a transition from a location in the executable to a location in an externally linked library.

10. A non-transitory machine-readable medium having executable instructions to cause one or more processing units to perform a method to dynamically generate an executable in memory of a device, the method comprising:
receiving source code for the executable;
generating an internal representation of the source code;
generating an object file in the memory of the device from the internal representation; and
dynamically linking the object file to resolve one or more external symbols in the object file to create the in-memory executable without storing the executable in a filesystem of the device, wherein the in-memory executable is debuggable and includes loader instructions embedded in the in-memory executable.

11. The non-transitory machine-readable medium of claim 1, wherein the method further comprises:
executing the in-memory executable.

12. The non-transitory machine-readable medium of claim 1, wherein the generation of the object file comprises:
converting each internal representation instruction in the internal representation of the source code into machine instructions and relocations, wherein the relocations include local and external relocations;
assembling each of the machine instructions into sections in segments;
resolving the local relocations; and
recording the external relocations.

13. The non-transitory machine-readable medium of claim 1, wherein the dynamic linking comprises:
receiving the object file, wherein the object file includes external relocations;
resolving the external relocations;
generating loader instructions;
generating a symbol table; and
loading debug information.

14. The non-transitory machine-readable medium of claim 1, wherein the filesystem is read-only.

15. The non-transitory machine-readable medium of claim 1, wherein the symbol table include symbol names and backtrace information.

16. The non-transitory machine-readable medium of claim 1, wherein a local relocation is a transition from a location in the executable to another location in the executable.

17. The non-transitory machine-readable medium of claim 1, wherein an external relocation is a transition from a location in the executable to a location in an externally linked library.

18. An apparatus comprising:
means for receiving source code for the executable;
means for generating an internal representation of the source code;
means for generating an object file in the memory of the device from the internal representation; and
means for dynamically linking the object file to resolve one or more external symbols in the object file to create an executable without storing the executable in a filesystem of the device.

19. The apparatus of claim 18, wherein the apparatus further comprises:
means for executing the in-memory executable.

20. The apparatus, wherein the filesystem is read-only.
